(19) United States
(12) Patent Application Publication
(10) Pub. No.: US 2005/0175016 A1
(43) Pub. Date: Aug. 11, 2005

(54) Method, medium, and apparatus for connecting heterogeneous protocol nodes

(75) Inventors: Pyung-soo Kim, Seoul (KR); Sun-woo Kim, Suwon-si (KR); Young-keun Kim, Incheon Metropolitan-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/050,910

(22) Filed: Feb. 7, 2005

(30) Foreign Application Priority Data
Feb. 6, 2004 (KR) 2004-7827

(51) Int. Cl. H04L 1/00

(52) U.S. Cl. 370/395.52

(57) ABSTRACT

A method, medium, and an apparatus for connecting heterogeneous protocol nodes including receiving first data through a first socket, with data transferred from a corresponding first node uses a first protocol, and transmitting the received first data for a second node, through a second socket, with the second node using the second protocol, whereby the nodes using heterogeneous protocols can be connected with each other.

### CROSS-REFERENCE TO RELATED APPLICATIONS

This application claims the benefit of Korean Patent Application No. 2004-7827, field on Feb. 6, 2004, in the Korean Intellectual Property Office, the disclosure of which is incorporated herein in its entirety by reference.

### BACKGROUND OF THE INVENTION

1. Field of the Invention

Embodiments of the present invention relate to a method, medium, and apparatus for connecting nodes that use heterogeneous protocols, and more particularly, to a method and an apparatus for connecting internet protocol version 4 (IPv4) nodes to internet protocol version 6 (IPv6) nodes, and also for connecting non-mobile nodes to mobile nodes.

2. Description of the Related Art

Nodes existing in a network including Internet protocol version 4 (IPv4) and Internet protocol version 6 (IPv6) may not be equipped with an IPv4/IPv6 conversion function in an IP layer of the network. In this case, IPv4 nodes and IPv6 nodes cannot be connected with each other in the prior art. In addition, IP nodes present in a mobile network may not be equipped with a mobile IP function in IP layers of the network. Accordingly, non-mobile nodes having no mobile IP function cannot be connected with mobile nodes having a mobile IP function. Moreover, since such an IP layer is included in the kernel level which users or terminal suppliers cannot manage, it is difficult for users or terminal suppliers to solve the above problems.

### SUMMARY OF THE INVENTION

Embodiments of the present invention provides a method, medium, and apparatus for connecting nodes that use heterogeneous protocols, and more particularly, to provide a method, medium, and apparatus which a user or a terminal supplier can implement easily.

Additional aspects and/or advantages of the invention will be set forth in part in the description which follows and, in part, will be obvious from the description, or may be learned by practice of the invention.

To achieve the above and/or other aspects and advantages, embodiments of the present invention set forth a method of connecting heterogeneous protocol nodes, the method including receiving first data transferred from a first node, which uses a first protocol, through a first socket, and transmitting the received first data to a second node, which uses a second protocol, through a second socket.

The first protocol may be IPv6 and the second protocol may be IPv4, or the second protocol may be IPv6 and the first protocol may be IPv4. Similarly, the first protocol may be a mobile IP and the second protocol may be a non-mobile IP, or the second protocol may be the mobile IP and the first protocol may be the non-mobile IP.

In the receiving of the first data transferred from the first node, the first data may be received through the first socket by calling a receive function in an application layer, with the receive function including information about the first socket and the first data, and in the transmitting of the received first data to the second node, the received first data may be transmitted through the second socket by calling a send function in the application layer, with the send function including information about the second socket and the information about the first data.

The method may further include generating the first socket and the second socket to be used in communication based on the first protocol and the second protocol, respectively, wherein in the receiving of the first data transferred from the first node, the first data may be received through the first socket generated in the generating of the first and second sockets, and in the transmitting of the received first data to the second node, the received first data may be transmitted through the second socket generated in the generating of the first and second sockets.

In addition, the method may include generating the first socket and the second socket to be used in communication based on the first protocol and the second protocol, respectively, and connecting the generated first socket to the first node and connecting the generated second socket to the second node, wherein in the receiving of the first data transferred from the first node, the first data may be received through the first socket connected in the generating of the first and second sockets, and in the transmitting of the received first data to the second node, the received first data may be transmitted through the second socket connected in the generating of the first and second sockets.

To achieve the above and/or other aspects and advantages, embodiments of the present invention set forth an apparatus for connecting heterogeneous protocol nodes, the apparatus including a first socket communicating unit receiving first data through a first socket, the first data transferred from a first node using a first protocol, and a second socket communicating unit transmitting the first data received by the first socket communicating unit to a second node through a second socket.

The first socket communicating unit may receive data through the first socket by calling a receive function in an application layer, with the receive function including information about the first socket and the received data, and the second socket communicating unit may transmit the received data through the second socket by calling a send function in an application layer, with the send function including information about the second socket and the information about the received data.

In addition, the apparatus may further include a dual socket generating unit generating the first socket and the second socket to be used in communication based on the first protocol and the second protocol, respectively, wherein the first socket communicating unit may receive data, through the first socket generated by the dual socket generating unit, and the second socket communicating unit may send data through the second socket, generated by the dual socket generating unit.

Further, the apparatus may include a dual socket generating unit generating the first socket and second socket to be used in the first protocol based communication and the second protocol based communication, respectively, and a dual socket connecting unit connecting the first socket with the first node and the second socket with the second node, with the first and second sockets being generated by the dual socket generating unit, wherein the first socket communicating unit may receive data through the first socket, connected by the dual socket connecting unit, and the second socket communicating unit may send data through the second socket, connected by the dual socket connecting unit.

To achieve the above and/or other aspects and advantages, embodiments of the present invention set forth a method of connecting heterogeneous protocol nodes, the method including generating a first socket and a second socket to be used in a first protocol based communication and a second protocol based communication, respectively, and communicating with a first node that uses the first protocol through the first socket generated in the generating of the first and second sockets and with a second node that uses the second protocol through the second socket generated in the generating of the first and second sockets.

In the generating of the first and second sockets, the first socket and the second socket, which are application program interfaces, may be generated by calling predetermined functions in an application layer.

In addition, communication may be performed through the first socket and the second socket, which are application program interfaces, by calling predetermined functions in an application layer.

To achieve the above and/or other aspects and advantages, embodiments of the present invention set forth a medium comprising computer readable code implementing embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a configuration diagram of a network environment, according to an exemplary embodiment of the present invention;

FIG. 2 is a configuration diagram of a network environment, according to an exemplary embodiment of the present invention;

FIG. 3 is a configuration diagram of another network environment, according to an exemplary embodiment of the present invention;

FIG. 4 is a configuration diagram of still another network environment, according to an exemplary embodiment of the present invention;

FIG. 5 is a configuration diagram of yet another network environment, according to an exemplary embodiment of the present invention;

FIG. 6 is a flowchart of a method of connecting heterogeneous protocol nodes, according to an exemplary embodiment of the present invention;

FIG. 7 is a flowchart of another method of connecting heterogeneous protocol nodes, according to an exemplary embodiment of the present invention;

FIG. 8 is a flowchart of still another method of connecting heterogeneous protocol nodes, according to an exemplary embodiment of the present invention; and

FIG. 9 is a flowchart of yet another method of connecting heterogeneous protocol nodes, according to an exemplary embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

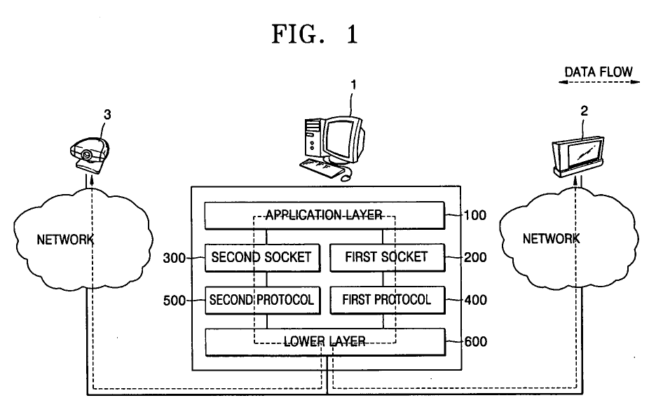

FIG. 1 is a configuration diagram of a network environment, according to an exemplary embodiment of the present invention.

Referring to FIG. 1, a network environment may include nodes 1, 2, and 3. According to this embodiment of the present invention, the node 1 may be equipped with a dual stack including both protocol stacks using a first protocol and a second protocol, with the node 2 using the first protocol, and the node 3 using the second protocol.

Referring to FIG. 1, the dual stack includes an application layer 100, a first socket 200, a second socket 300, a first protocol 400, a second protocol 500, and a lower layer 600 according, to th embodiment of the present invention. In the dual stack, the right stack includes the first protocol 400 and the left stack includes the second protocol 500. The application layer 100 and the lower layer 600 of the dual stack may be common layers.

The node 1 generates the first socket 200, which is an application program interface (API) to be used for a first protocol based communication, and a second socket 300, which is an API to be used for the second protocol based communication by calling functions for connection with specific subroutines in the application layer 100. Here, the specific subroutine relates to generating sockets.

The node 1 communicates with the first node 2, which uses the first protocol 400 through the first socket 200 generated by calling functions for connection with specific subroutines in the application layer, and with the second node 3, which uses the second protocol 500 through the second socket 300 generated by calling functions for connection with specific subroutines in the application layer. Here, specific subroutines relate to communicating through sockets. In other words, the data transmitted from the node 2, which uses the first protocol 400 is transferred to the node 1 via a network. The data received by the node 1 passes the lower layer 600, the first protocol 400 and the first socket 200, and then arrives at the application layer 100. The data arriving at the application layer 100 passes the second socket 300, the second protocol 500 and the lower layer 600. The node 3 receives the data having passed the lower layer 600 via a network. The reverse flow of data can also similarly be established.

As described above, the node 1 communicates with the first node 2, which uses the first protocol 400 through the first socket 200, and with the second node 3, using the second protocol 500 through the second socket 300. Accordingly, even when layers of the kernel level, which users or terminal suppliers cannot manage, that is, the first protocol 400 and the second protocol 500 do not include a conversion mechanism between the first protocol 400 and the second protocol 500, the node 1 implements the communication with the node 2 and the node 3. Here, the first protocol 400 may be IPv6 and the second protocol 500 may be IPv4, or vice versa. Also the first protocol 400 may be a mobile IP and the second protocol 500 may be a non-mobile IP, or vice versa. Each of the above matters will now be described more specifically below.

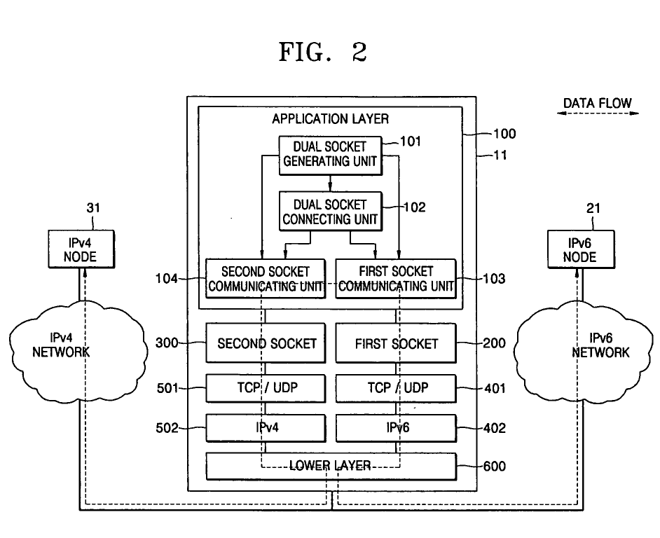

FIG. 2 is a configuration diagram of a first network environment, according to an exemplary embodiment of the present invention.

Referring to FIG. 2, the network environment may include a node 11 including an apparatus for connecting heterogeneous protocol nodes, an IPv6 node 21 that corresponds to a client, and an IPv4 node 31 that corresponds to a server, according to this embodiment of the present invention. The node 11 plays a role as a server, corresponding to the IPv6 node 21, and concurrently plays a role as a client, corresponding to the IPv4 node 31.

Referring to FIG. 2, the apparatus for connecting heterogeneous protocol nodes includes a dual socket generating unit 101, a dual socket connecting unit 102, a first socket communicating unit 103, and a second socket communicating unit 104, according to this embodiment of the present invention. As shown in FIG. 2, the apparatus for connecting heterogeneous protocol nodes is mounted on an application layer 100.

The dual socket generating unit 101 generates a first socket 200 to be used for IPv6 communication of any application program and the second socket 300 to be used for IPv4 communication of the application program. In more detail, the dual socket generating unit 101, as a server and client, generates the first socket 200 by calling a socket ( ), i.e., a socket function, in the application layer 100, the socket ( ) including information about IPv6. The socket ( ) is defined as a type of int socket (int family, int type, int protocol). As an example, PF_INET can be written in a family field of a socket ( ) for generating the first socket 200, to denote that the Internet protocol family is used, SOCK_STREAM can be written in a type field to denote that TCP (transmission control protocol) of connection oriented communication is used, and IPv6 can be written in a protocol field to indicate use of IPv6. If UDP (user datagram protocol) of a non-connection oriented communication is used, instead of the SOCK_STREAM, SOCK_DGRAM can be written in a type field. In addition, the dual socket generating unit 101 generates the second socket 300 by calling a socket ( ) in the application layer 100, with the socket ( ) including information about IPv4, except that IPv4 is written in a protocol field of a socket ( ) so as to identify use of IPv4, noting that a socket ( ) for generating the second socket 300 is identical to the socket ( ) for generating the first socket 200 .

Moreover, the dual socket generating unit 101, as a server, connects an address of the node 11 with the first socket 200 by calling a bind ( ) connect function in the application layer 100, with the connect function including information about the first socket 200 and an address of the node 11 set as the destination of the IPv6 node 21. The bind ( ) is defined as a type of int bind (int sockfd, struct sockaddr *myaddr, int addrlen). A socket descriptor of the first socket 200 is written in a sockfd field of a bind ( ) for connecting an address with the first socket 200, an address structure including an IPv6 address and a port number, which are supplied by TCP/UDP 401 and IPv6 402, is written in a myaddr field, and a size of the address structure is written in an addrlen field. The bind ( ) is called in order to connect the IPv6 address and a port number of the node 11 known by IPv6 node 21 with a socket descriptor of the first socket 200 because the socket descriptor of the first socket 200 is known and used by only an application program of the node 11.

The dual socket connecting unit 102 connects the first socket 200 and the second socket 300, generated in the dual socket generating unit 101, with the IPv6 node 21 and the IPv4 node 31, respectively. More specifically, the dual socket connecting unit 112, as a server, waits to receive a connection request of which destination is an address connected with the first socket 200, by calling a listen ( ), of a wait function, in an application layer 100, the listen ( ) including information about the first socket 200. The listen ( ) is defined as a type of int listen (int sockfd, int backlog). A socket descriptor of the first socket 200 is written in a sockfd field of a listen ( ), for receiving a connection request of which destination is an address connected with the first socket 200, and the maximum number of connection requests available to be waited for is written in a backlog field.

Further, the dual socket connecting unit 102, as a server, admits the received connection request by calling an accept ( ), of an accept function, in the application layer 100, with the accept function including information about the first socket 200 and an address of the IPv6 node 21 that sent the connection request. Here, a new socket is generated for one to one communication with a process, contained in an application program, which is performed in the IPv6 node 21 corresponding to a client. The accept ( ) is defined as a type of int accept (int sockfd, struct sockaddr *clientaddr, int addrlen). A socket descriptor of the first socket 200 is written in a sockfd field of an accept ( ) for admitting a connection request from the IPv6 node 21 corresponding to a client, an address structure is written in a clientaddr field, the address structure including an IPv6 address and a port number of the IPv6 node 21, and a size of the address structure is written in an addrlen field.

In addition, the dual socket connecting unit 102, as a client, requests to connect to the IPv4 node 31 by calling a connect ( ), of a connect function, in the application layer 100, with the connect ( ) including information about the second socket 300 and an address of the IPv4 node 31 waiting to receive a connection request. The connect ( ) is defined as a type of int connect (int sockfd, struct sockaddr *serveraddr, int addrlen). A socket descriptor of the second socket is written in a sockfd field of the connect ( ) for requesting to connect to the IPv4 node 31, acting as a server, an address structure is written in a serveraddr, the address structure including an IPv4 address and a port number of the IPv4 node 31, and a size of the address structure is written in an addrlen field.

The first socket communicating unit 103 receives data transferred from the IPv6 node 21 through the first socket 200, generated in the dual socket generating unit 101, when the node 11 uses UDP, or receives data transferred from the IPv6 node 21 through the first socket 200 connected in the dual socket connecting unit when the node 11 uses TCP. This is because that a listen ( ) and an accept ( ) should be called in case of connection oriented communication such as TCP but data can be received and transmitted directly without calling a listen ( ) and an accept ( ) in case of non-connection oriented communication such as UDP.

More particularly, the first socket communicating unit 103, as a server, receives data transferred from the IPv6 node 21 through the first socket 200 by calling a recv ( ) or a recvfrom ( ), of a receive function, in the application layer 100, with the receive function including information about the first socket 200 and the data transferred from the IPv6 node 21. The second socket communicating unit 104, as a client, sends data transferred from the IPv6 node 21 through the second socket 300 by calling a send ( ) or a sendto ( ), of a send function, in the application layer 100, with the send function including information about the second socket 300 and the data transferred from the IPv6 node 21. A recv ( ) and send ( )are called in connection oriented communication such as TCP, or a recvfrom ( ) and a sendto ( ) are called in non-connection oriented communication such as UDP.

The recv ( ) is defined as a type of int recv (int sockfd, char buf, int buflen, int flags). A socket descriptor of the first socket 200 is written in a sockfd field of the recv ( ) for receiving data transferred from the IPv6 node 21 through the first socket 200, with the pointer of a buffer storing the received data in a buf field, a size of the buffer being written in a buflen field, and a value indicating out of band, etc., is written in a flags field. On the other hand, the recvfrom ( ) is defined as a type of int recvfrom (int sockfd, char buf, int buflen, int flags, struct sockaddr *fromaddr, int addrlen). That is, the value identical with the recv ( ) is written in a sockfd field, a buf field, a buflen field, and a flags field of the recvfrom ( ) for receiving data through the first socket 200, a source address structure is written in a fromaddr field, with the source address structure including an IPv6 address and a port number of the IPv6 node 21 and a size of the source address structure being written in an addrlen field.

The send ( ) is defined as a type of int send (int sockfd, char buf, int buflen, int flags). A socket descriptor of the second socket 300 is written in a sockfd field of the send ( ) for transmitting data transferred from the IPv6 node 21 through the second socket 300; the pointer of the buffer that stores data to be sent is written in a buf field, the pointer being identical with the value of the recv ( ); and value indicating out of band etc. is written in a flags field, the value being identical with the value of the recv ( ). This process is applicable to the IPv6 to IPv4 transition process in the application layer 100. On the other side, the sendto ( ) is defined as a type of int sendto (int sockfd, char buf, int buflen, int flags, struct sockaddr *toaddr, int addrlen). That is, the valued identical with the send ( ) is written in a sockfd field, a buf field, a buflen field and a flags field of the sendto ( ) for transmitting data transferred from the IPv6 node 21 through the second socket 300, a source address structure is written in a toaddr field, the source address structure including an IPv4 address and a port number of the IPv4 node 31, and a size of the address structure is written in an addrlen field.

Further, the second socket communicating unit 104 receives data transferred from the IPv4 node 31 through the second socket 300, generated in the dual socket generating unit 101, when the node 11 uses UDP, or receives data transferred from the IPv4 node 31 through the second socket 300 connected with the dual socket connecting unit 102 when the node 11 uses TCP. The first socket communicating unit 103 sends data transferred from the IPv4 node 31 through the first socket 200 generated in the dual socket generating unit 101 when the node 11 uses UDP, or sends data transferred from the IPv4 node 31 through the first socket 200 connected with the dual socket connecting unit 102.

More specifically, the second socket communicating unit 104, as a server, receives data transferred from the IPv4 node 31 through the second socket 300 by calling a recv ( ) or a recvfrom ( ) of a receive function in the application layer 100, with the receive function including information about the second socket 300 and the data transferred from the IPv4 node 31. The first socket communicating unit 103, as a client, sends data transferred from the IPv4 node 31 through the first socket 200 by calling a send ( ) or a sendto ( ) of a send function in the application layer 100, with the send function including information about the first socket and the data transferred from the IPv4 node 31.

A socket descriptor of the second socket 300 is written in a sockfd field of a recv ( ) for receiving data transferred from the IPv4 node 31 through the second socket 300; a buffer pointer storing the received data is written to in a buf field; a size of the buffer is written in a buflen field; and value indicating out of band etc. is written in a flags field. On the other hand, the values identical with the recv ( ) are written in a sockfd field, a buf field, a buflen field and a flags field of the recvfrom ( ) for receiving data transferred from the IPv4 node 31 through the second socket 300; a source address structure is written in a fromaddr field, with the source address structure including an IPv4 address and a port number of the IPv4 node 31; and a size of the address structure is written in an addrlen field.

A socket descriptor of the first socket 200 is written in a sockfd of the send ( ),for transmitting data transferred from the IPv4 node 31 through the first socket 200; a pointer of a buffer that stores data to be sent is written in a buf field, the pointer being identical with the value of the recv ( ); and a value indicating out of band, etc., is written in a flags field, the value being identical with the value of the recv ( ). This process is applicable to the IPv4 to IPv6 transition process in the application layer 100. On the other side, the value identical with the send ( ) is written in a sockfd field, a buf field, a buflen field and a flags field of a sendto ( ) for transmitting data transferred from the IPv4 node 31 through the first socket 200; a source address structure is written in a toaddr field, the source address structure including an IPv6 address and a port number of the IPv6 node 21; and a size of the address structure is written in an addrlen field.

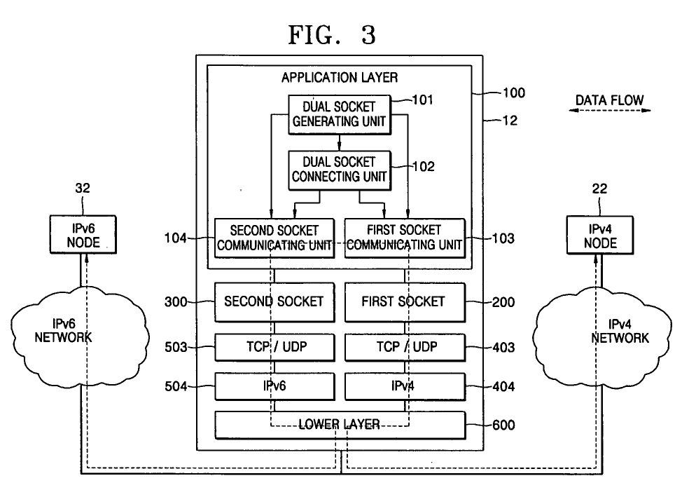

FIG. 3 is a configuration diagram of another network environment according to another exemplary embodiment of the present invention.

Referring to FIG. 3, the network environment includes a node 12 equipped with an apparatus for connecting heterogeneous protocol nodes, an IPv4 node 22, acting as a client, and the IPv6 node 32, acting as a server. The node 12 plays a role of a server, with reference to the IPv4 node 22, and concurrently also plays a role of a client, with reference to the IPv6 node 32. Embodiments of the present invention now will be described more specifically focused on the differences between the network environment of FIG. 2 and the network environment of FIG. 3, omitting the similarities between the two network environments.

As illustrated in FIG. 3, the dual socket generating unit 101 generates the first socket 200 to be used for IPv4 communication of any application program and the second socket 300 to be used for IPv6 communication of the application program. The dual socket generating unit 101, as a server and client, generates the first socket 200 by calling a socket ( ) of a socket function in an application layer 100, with the socket ( ) including information about IPv4. IPv4 is written in a protocol field of the socket ( ) for generating the first socket 200 so as to indicate use of IPv4. The dual socket generating unit 101 generates the second socket 300 by calling a socket ( ) in the application layer, with the socket ( ) including information about IPv6. IPv6 is written in a protocol field of the socket ( ) for generating the second socket 300 so as to indicate use of IPv6. Moreover, the dual socket generating unit 101, as a server, connects an address of the node 12 with the first socket 200 by calling a bind ( ), of a connect function, in the application layer 100, the connect function including information about the first socket 200 and an address of the node 12 set as the destination of the IPv4 node 22. An address structure is written in a myaddr field of the bind ( ) for connecting the address with the first socket 200, the address structure including an IPv4 address and a port number supplied by TCP/UDP 403 and IPv4 404.

The dual socket connecting unit 102, as a server, admits the received connection request by calling an accept ( ), of an accept function, in the application layer 100, with the accept function including information about the first socket 200 and the address of the IPv4 node 22 that sent the connection request. An address structure is written in a clientaddr field of the accept ( ) for admitting the connection request from the IPv4 node 22, acting as a client, the address structure including an IPv4 address and a port number of the IPv4 node 22; and a size of the address structure is written in an addrlen field.

In addition, the dual socket connecting unit 102, as a client, requests to connect to the IPv6 node 32 by calling a connect ( ), of a connect function, in the application layer 100, with the connect function including information about the second socket 300 and an address of the IPv6 node 32 waiting to receive a connection request. An address structure is written in a serveraddr of a connect ( ) for requesting to connect to the IPv6 node 32 corresponding to a server, with the address structure including an IPv6 address and a port number of the IPv6 node 32.

The first socket communicating unit 103 receives data transferred from the IPv4 node 22 through the first socket 200 generated in the dual socket generating unit 101 when the node 12 uses UDP, or receives data transferred from the IPv4 node 22 through the first socket 200 connected with the dual socket connecting unit 102 when the node 12 uses TCP. The second socket communicating unit 104 receives data transferred from the IPv4 node 22 through the second socket 300 generated in the dual socket generating unit 101 when the node 12 uses UDP, or receives data transferred from the IPv4 node 22 through the second socket 300 connected with the dual socket connecting unit 102 when the node 12 uses TCP.

The first socket communicating unit 103, as a server, receives data transferred from the IPv4 node 22 through the first socket 200 by calling a recv ( ) or a recvfrom ( ), of a receive function, in the application layer 100, with the receive function including information about the first socket 200 and the data transferred from the IPv4 node 22. The second socket communicating unit 104, as a client, sends data transferred from the IPv4 node 22 through the second socket 300 by calling a send ( ) or a sendto ( ), of a send function, in the application layer 100, with the send function including information about the second socket and the data transferred from the IPv4 node 22.

A source address structure is written in a fromaddr field of the recvfrom for receiving data, with the source address structure including an IPv4 address and a port number of the IPv4 node 22, and a size of the source address structure is written in an addrlen field.

A socket descriptor of the second socket 300 is written in a sockfd field of the send ( ) for transmitting data transferred from the IPv4 node 22 through the second socket 300; a pointer of a buffer that stores data to be sent is written in a buf field, the pointer being identical with the value of the recv ( ); a size of the buffer is written in a buflen field, the size being identical with the value of the recv ( ); and value indicating out of band, etc., is written in a flags field, the value being identical with the value of the recv ( ). This process is applicable to the IPv4 to IPv6 transition process in the application layer 100. On the other side, a source address structure is written in a toaddr field of a toaddr field for transmitting data transferred from the IPv4 node 22 through the second socket 300, the source address structure including an IPv6 address and a port number of the IPv6 node 32.

Further, the second socket communicating unit 104 receives data transferred from the IPv6 node 32 through the second socket 300, generated in the dual socket generating unit 101, when the node 12 uses UDP, or receives data transferred from the IPv4 node 22 through the second socket 300 connected with the dual socket connecting unit 102 when the node 12 uses TCP. The first socket communicating unit 103 sends data transferred from the IPv6 node 32 through the first socket 200, generated in the dual socket generating unit 101, when the node 12 uses UDP, or sends data transferred from the IPv6 node 32 through the first socket 200 connected with the dual socket connecting unit 102 when the node 12 uses TCP.

The second socket communicating unit 104, as a server, receives data transferred from the IPv6 node 32 through the second socket 300 by calling a recv ( ) or a recvfrom ( ), of a receive function, in the application layer 100, with the receive function including information about the second socket 300 and the data transferred from the IPv6 node 32. The first socket communicating unit 103, as a client, sends data transferred from the IPv6 node 32 through the first socket 200 by calling a send ( ) or a sendto ( ), of a send function, in the application layer 100, with the send function including information about the first socket and the data transferred from the IPv6 node 32.

A source address structure is written in a fromaddr field of the recvfrom ( ) for receiving data transferred from the IPv6 node 32 through the second socket 300, with the source address structure including an IPv6 address and a port number of the IPv6 node 32.

A socket descriptor of the first socket 200 is written in a sockfd field of the send ( ) for transmitting data transferred from the IPv6 node 32 through the first socket 200; a pointer of a buffer storing the data to be sent is written in a buf field, with the pointer being identical with the value of the recv ( ); a size of the buffer is written in a buflen field, with the size being identical with the value of the recv ( ); and a value indicating out of band, etc., is written in a flags field, the value being identical with the value of the recv ( ). This process is applicable to the IPv6 to IPv4 transition process in the application layer 100. On the other hand, the source address structure is written in a toaddr field of the sendto ( ) for transmitting data transferred from the IPv6 node 32 through the first socket 200, with the source address structure including an IPv4 address and a port number of the IPv4 node 22.

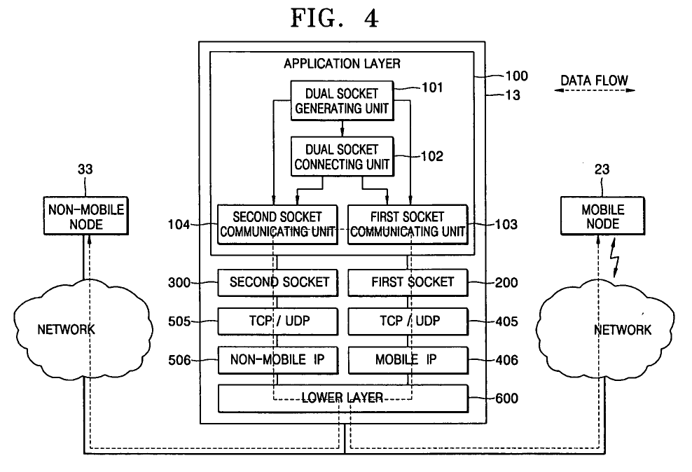

FIG. 4 is a configuration diagram of another network environment, according to still another exemplary embodiment of the present invention.

Referring to FIG. 4, the network environment includes a node 13 that is equipped with an apparatus for connecting heterogeneous protocol nodes, a mobile node 23, which acts as a client, and a non-mobile node 33, which acts as a server. The node 13 plays a role of a server with the mobile node 23, and concurrently plays the role of a client with the non-mobile node 33. Embodiments of the present invention now will be described more specifically focused on differences between the network environment of FIG. 2 and the network environment of FIG. 4, omitting the similarities between the two network environments.

The dual socket generating unit 101 generates the second socket 300 to be used for mobile communication of any application program and the second socket 300 to be used for non-mobile IP communication of the application program. The dual socket generating unit 101, as a server and client generates the first socket 200 by calling a socket ( ), of a socket function, in the application layer 100, with the socket ( ) including information about mobile IP. The mobile IP is written in a protocol field of the socket ( ) for generating the first socket 200 so as to indicate use of a mobile IP. The dual socket generating unit 101 generates the second socket 300 by calling a socket ( ) in the application layer, with the socket ( ) including information about the non-mobile IP. The non-mobile IP is written in a protocol field of the socket ( ) for generating the second socket 300 so as to indicate use of a non-mobile IP. Moreover, the dual socket generating unit 101, as a server, connects an address of the node 13 with the first socket 200 by calling a bind ( ), of a connect function, in the application layer 100, with the connect function including information about the first socket 200 and an address of the node 13 set as the destination of the mobile node 23. An address structure is written in a myaddr field of the bind ( ) for connecting the address with the first socket 200, with the address structure including a mobile IP address and a port number supplied by TCP/UDP 405 and the mobile IP 406.

The dual socket connecting unit 122, as a server, admits the received connection request by calling an accept ( ), of an accept function, in the application layer 100, with the accept function including information about the first socket 200 and the address of the mobile node 23 that sent the connection request. An address structure is written in a clientaddr field of the accept ( ) for admitting the connection request from the mobile node 23 corresponding to a client, the address structure including a mobile IP address and a port number of the mobile node 23, and a size of the address structure is written in an addrlen field.

In addition, the dual socket connecting unit 102, as a client, requests to connect to the non-mobile node 33 by calling a connect ( ), of connect function, in the application layer 100, with the connect function including information about the second socket 300 and an address of the non-mobile node 33 that waits to receive a connection request. An address structure is written in a serveraddr of a connect ( ) for requesting to connect to the non-mobile node 33 corresponding to a server, the address structure including a non-mobile IP address and a port number of the non-mobile node 33.

The first socket communicating unit 103 receives data transferred from the mobile node 23 through the first socket 200, generated in the dual socket generating unit 101, when the node 13 uses UDP, or receives data transferred from the mobile node 23 through the first socket 200 connected with the dual socket connecting unit 102 when the node 13 uses TCP. The second socket communicating unit 104 receives data transferred from the mobile node 23 through the second socket 300 generated in the dual socket generating unit 101 when the node 13 uses UDP, or receives data transferred from the mobile node 23 through the second socket 300 connected in the dual socket connecting unit 102 when the node 13 uses TCP.

The first socket communicating unit 103, as a server, receives data transferred from the mobile node 23 through the first socket 200 by calling a recv ( ) or a recvfrom ( ), of a receive function, in the application layer 100, with the receive function including information about the first socket 200 and information about the data which is transferred from the mobile node 23. The second socket communicating unit 104, as a client, sends data transferred from the mobile node 23 through the second socket 300 by calling a send ( ) or a sendto ( ), of a send function, in the application layer 100, with the send function including information about the second socket 300 and information about the data which is transferred from the mobile node 23.

A source address structure is written in a fromaddr field of the recvfrom ( ) for receiving data through the first socket 200, the source address structure including a mobile IP address and a port number of the mobile node 23; and a size of the source address structure is written in an addrlen field.

A socket descriptor of the second socket 300 is written in a sockfd field of the send ( ) for transmitting data transferred from the mobile node 23 through the second socket 300; a pointer of a buffer storing data to be sent is written in a buf field, the pointer being identical with the value of the recv ( ); and a size of the value identical with a buffer is written in a buflen field; and value indicating out of band, etc., is written in a flags field, the value being identical with the value of the recv ( ). This process is applicable to the mobile IP to non-mobile IP transition process in the application layer 100. On the other side, the source address structure is written in a toaddr field of the sendto ( ) for transmitting data transferred from the mobile node 23 through the second socket 300, with the source address structure including a non-mobile IP address and a port number of the non-mobile node 33.

Further, the second socket communicating unit 104 receives data transferred from the non-mobile node 33 through the second socket 300, generated in the dual socket generating unit 101, when the node 13 uses UDP, or receives data transferred from the non-mobile node 33 through the second socket 300 connected with the dual socket connecting unit 102 when the node 13 uses TCP. The first socket communicating unit 103 sends data transferred from the non-mobile node 33 through the first socket 200, generated in the dual socket generating unit 101, when the node 13 uses UDP, or sends data transferred from the non-mobile node 33 through the first socket 200 connected with the dual socket connecting unit 102 when the node 13 uses TCP.

The second socket communicating unit 104, as a server, receives data transferred from the non-mobile node 33 through the second socket 300 by calling a recv ( ) or a recvfrom ( ), of a receive function, in the application layer 100, with the receive function including information about the second socket 300 and information about the data which is transferred from the non-mobile node 33. The first socket communicating unit 103, as a client, sends data transferred from the non-mobile node 33 through the first socket 200 by calling a send ( ) or a sendto ( ), of a send function, in the application layer 100, with the send function including information about the first socket and information about the data which is transferred from the non-mobile node 33.

A source address structure is written in a fromaddr field of the recvfrom ( ) for transmitting data transferred from the non-mobile node 33 through the second socket 300, the source address structure including a non-mobile IP address and a port number of the non-mobile node 33.

A socket descriptor of the first socket 200 is written in a sockfd field of the send ( ) for transmitting data transferred from the non-mobile node 33 through the second socket 300; a pointer of a buffer storing data to be sent is written in a buf field, the pointer being identical with the value of the recv ( ); a size of the buffer is written in a buflen field, the size being identical with the value of the recv ( ); value indicating out of band, etc., is written in a flags field, the value being identical with the value of the recv ( ). This process is applicable to the non-mobile IP to mobile IP transition process in the application layer 100. On the other hand, a source address structure is written in a toaddr field of the sendto ( ) for transmitting data transferred from the non-mobile node 33 through the first socket 200, the source address structure including a mobile IP address and a port number of the mobile IP node 23.

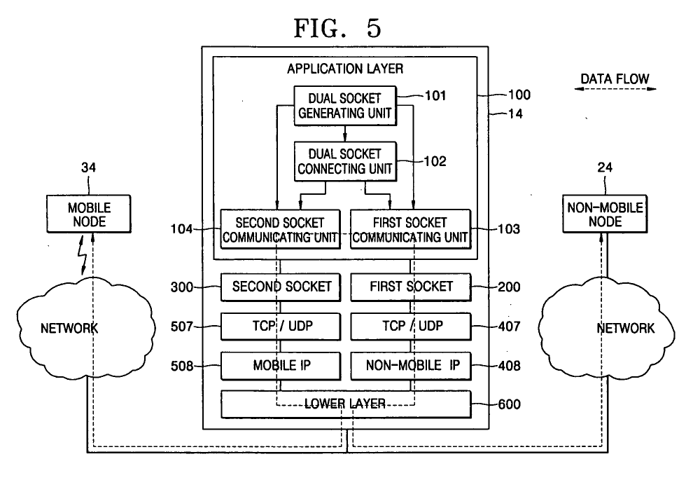

FIG. 5 is a configuration diagram of another network environment, according to yet another exemplary embodiment of the present invention.

Referring to FIG. 5, the network environment includes a node 14 which is equipped with an apparatus for connecting heterogeneous protocol nodes, a non-mobile node 24, acting as a client, and the mobile node 34, acting as a server. The node 14 plays a role of a server, with respect to the non-mobile node 24, and concurrently plays a role of a client, with respect to the mobile node 34. Embodiments of the present invention now will be described more specifically focused on differences between the network environment of FIG. 2 and the network environment of FIG. 5, omitting the similarities between the two network environments.

The dual socket generating unit 101 generates the first socket 200 to be used for non-mobile communication of any application program and the second socket 300 to be used for mobile IP communication of the application program. The dual socket generating unit 101, as a server and client, generates the first socket 200 by calling a socket ( ), of a socket function, in the application layer 100, with the socket ( ) including information about the non-mobile IP. The non-mobile IP is written in a protocol field of a socket ( ) for generating the first socket 200 so as to indicate use of mobile IP. The dual socket generating unit 101 generates the second socket 300 by calling a socket ( ) in the application layer, with the socket ( ) including information about the mobile IP. The mobile IP is written in a protocol field of the socket ( ) for generating the second socket 300 so as to indicate use of a mobile IP. Moreover, the dual socket generating unit 101, as a server, connects an address of the node 14 with the first socket 200 by calling a bind ( ), of a connect function, in the application layer 100, with the connect function including information about the first socket 200 and an address of the node 14 set as the destination of the non-mobile node 24. An address structure is written in a myaddr field of the bind ( ) for connecting the address with the first socket 200, the address structure including a non-mobile IP address and a port number supplied by TCP/UDP 407 and the non-mobile IP 408.

The dual socket connecting unit 102, as a server, admits the received connection request by calling an accept ( ), of an accept function, in the application layer 100, with the accept function including information about the first socket 200 and the address of the non-mobile node 24 that sent the connection request. An address structure is written in a clientaddr field of an accept ( ) for admitting the connection request from the non-mobile node 24, acting as a client, the address structure including a non-mobile IP address and a port number of the non-mobile node 24, and a size of the address structure is written in an addrlen field.

In addition, the dual socket connecting unit 102, as a client, requests to connect to mobile node 34 by calling a connect ( ), of a connect function, in the application layer 100, with the connect function including information about the second socket 300 and an address of the mobile node 34 that waits to receive a connection request. An address structure is written in a serveraddr of a connect ( ) for requesting to connect to the mobile node 34, acting as a server, the address structure including a mobile IP address and a port number of the mobile node 34.

The first socket communicating unit 103 receives data transferred from the non-mobile node 24 through the first socket 200, generated in the dual socket generating unit 101, when the node 14 uses UDP, or receives data transferred from the non-mobile node 24 through the first socket 200 connected with the dual socket connecting unit 102 when the node 14 uses TCP. The second socket communicating unit 104 sends data transferred from the non-mobile node 24 through the second socket 300 generated in a dual socket generating unit 101 when the node 14 uses UDP, or sends data transferred from the non-mobile node 24 through the second socket 300 connected with the dual socket connecting unit 102 when the node 14 uses TCP.

The first socket communicating unit 103, as a server, receives data transferred from the non-mobile node 24 through the first socket 200 by calling a recv ( ) or a recvfrom ( ), of a receive function, in the application layer 100, with the receive function including information about the first socket 200 and information about the data which is transferred from the non-mobile node 24. The second socket communicating unit 104, as a client, sends data transferred from the non-mobile node 24 through the second socket 300 by calling a send ( ) or a sendto ( ), of a send function, in the application layer 100, with the send function including information about the second socket 300 and information about the data which is transferred from the non-mobile node 24.

A source address structure is written in a fromaddr field of a recvfrom ( ) for receiving data through the first socket 200, the source address structure including a non-mobile IP address and a port number of the non-mobile node 24; and a size of the source address structure is written in an addrlen field.

A socket descriptor of the second socket 300 is written in a sockfd field of a send ( ) for transmitting data transferred from the non-mobile node 24 through the second socket 300; a pointer of a buffer storing data to be sent is written in a buf field, the pointer being identical with the value of a recv ( ); and a size of the buffer is written in a buflen field, the size being identical with the value of a recv ( ); and a value indicating out of band, etc., is written in a flags field, the value being identical with the value of a recv ( ). This process is applicable to the non-mobile IP to mobile IP transition process in the application layer 100. On the other side, a source address structure is written in a toaddr field of a sendto ( ) for transmitting data transferred from the non-mobile node 24 through the second socket 300, the source address structure including a mobile IP address and a port number of the mobile node 34.

Further, the second socket communicating unit 104 receives data transferred from the mobile node 34 through the second socket 300, generated in a dual socket generating unit 101, when the node 14 uses UDP, or receives data transferred from the mobile node 34 through the second socket 300 connected with the dual socket connecting unit 102 when the node 14 uses TCP. The first socket communicating unit 103 sends data transferred from the mobile node 34 through the first socket 200, generated in a dual socket generating unit 101, when the node 14 uses UDP, or sends data transferred from the mobile node 34 through the first socket 200 connected with the dual socket connecting unit 102 when the node 14 uses TCP.

The second socket communicating unit 104, as a server, receives data transferred from the mobile node 34 through the second socket 300 by calling a recv ( ) or a recvfrom ( ), of a receive function, in the application layer 100, with the receive function including information about the second socket 300 and information about the data which is transferred from the mobile node 34. The first socket communicating unit 103, as a client, sends data transferred from the mobile node 34 through the first socket 200 by calling a send ( ) or a sendto ( ), of a send function, in the application layer 100, with the send function including information about the first socket 200 and information about the data which is transferred from the mobile node 34.

A source address structure is written in a fromaddr field of a recvfrom ( ) for receiving data transferred from the mobile node 34 through the second socket 300, the source address structure including a mobile IP address and a port number of the mobile node 34.

A socket descriptor of the first socket 200 is written in a sockfd field of a send ( ) for transmitting data transferred from the mobile node 34 through the first socket 200; a pointer of a buffer storing data to be sent is written in a buf field, the pointer being identical with the value of the recv ( ); a size of the buffer is written in a buflen field, the size being identical with the value of the recv ( ); and a value indicating out of band, etc., is written in a flags field, the value being identical with the value of the recv ( ). This process is applicable to the mobile IP to non-mobile IP transition process in the application layer 100. On the other hand, a source address structure is written in a toaddr field of a sendto ( ) for transmitting data transferred from the mobile node 34 through the first socket 200, the source address structure including a non-mobile IP address and a port number of the non-mobile node 24.

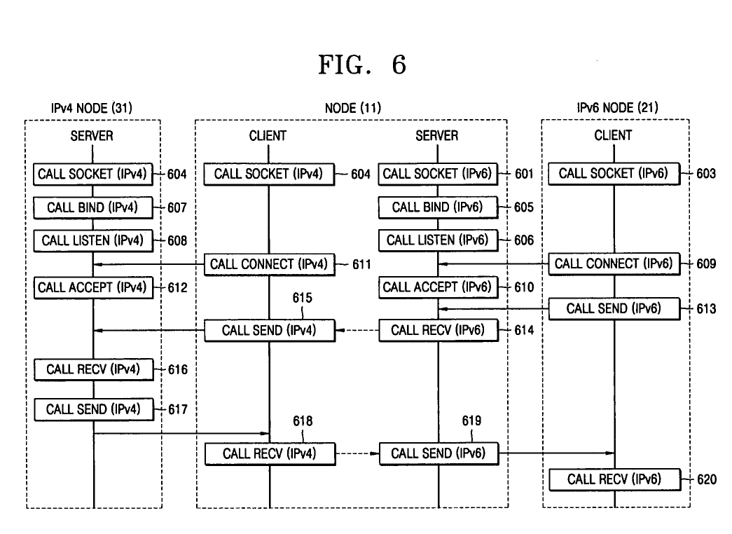

FIG. 6 is a flowchart of a method of connecting heterogeneous protocol nodes, according to an exemplary embodiment of the present invention.

Referring to FIG. 6, the method of connecting heterogeneous protocol nodes includes operations of as described below. The method of connecting heterogeneous protocol nodes can be implemented in a network environment illustrated in FIG. 2, for example.

First, the node 11, as a server and client, generates the first socket by calling a socket (IPv6) in the application layer, the socket (IPv6) including information about IPv6, and the second socket by calling a socket (IPv4) in the application layer, the socket (IPv4) including information about IPv4 (operations 601 and 602). At the same time, the IPv6 node 21 generates the third socket by calling the socket (IPv6) that includes information about IPv6, and the IPv4 node 31 generates a fourth socket by calling a socket (IPv4) that includes information about IPv4 (operations 603 and 604).

Subsequently, the node 11, as a server, connects an address of the node 11 with the first socket by calling a bind (IPv6) in the application layer, with the bind (IPv6) including information about the first socket and an address of the node 11 set as a destination by the IPv6 node 21 (operation 605). Next, the node 11, as a server, waits to receive a connection request of which destination is an address connected with the first socket by calling a listen (IPv6) in the application layer, with the listen (IPv6) including information about the first socket (operation 606). Simultaneously, the IPv4 node 31, as a server, connects an address of the IPv4 node with the fourth socket by calling a bind (IPv4) in the application layer, with the bind (IPv4) including information about the fourth socket (operation 607). Then the IPv4 node 31, as a server, waits to receive a connection request of which destination is an address connected with the fourth socket by calling a listen (IPv4) in the application layer, with the listen (IPv4) including information the fourth socket (operation 608).

Thereafter, the IPv6 node 21, as a client, requests to connect to the node 11 by calling a connect (IPv6) in the application layer, with the connect (IPv6) including information about the third socket and an address of the node 11 that waits to receive a connection request (operation 609). Next, the node 11, as a server, admits the connection request by calling an accept (IPv6) in the application layer, with the accept (IPv6) including information about the first socket, and an address of the IPv6 node 21 that sent the connection request (operation 610). At the same time, the node 11, as a client, requests to connect to the IPv4 node 31 by calling a connect (IPv4) in the application layer, with the connect (IPv4) including information about the second socket and an address of the IPv4 node 31 that waits to receive a connection request (operation 611). Then the IPv4 node 31 admits the received connection request by calling an accept (IPv4) in the application layer, with the accept (IPv4) including information the fourth socket and an address of the node 11 that sent the connection request (operation 612). In case of a non-mobile communication such as UDP, the operations of calling a listen ( ), a connect ( ), and an accept ( ) can be omitted.

Next, the IPv6 node 21, as a client, transmits data (from the IPv6 node 21) through the third socket by calling a send (IPv6) in the application layer, with the send (IPv6) including information about the third socket and information about data transferred from the IPv6 node 21 (operation 613). Subsequently, the node 11, as a server, receives data transferred from the IPv6 node 21 through the first socket by calling a recv (IPv6) in the application layer, with the recv (IPv6) including information about the first socket and data transferred from the IPv6 node 21 (operation 614). Thereafter the node 11 transmits data transferred from the IPv6 node 21 through the second socket by calling a send (IPv4) in the application layer, with the data including information about the second socket and data transferred from the IPv6 node 21 (operation 615). This process is applicable to the IPv6 to IPv4 transition process in the application layer. Next, the IPv4 node 31, as a server, receives data transferred from the IPv6 node 21 through the fourth socket by calling a recv (IPv4) in the application layer, with the recv (IPv4) including information the fourth socket and the data transferred from the IPv6 node 21 (operation 616). The IPv4 node 31 processes the data transferred from the IPv6 node 21.

Subsequently, the IPv4 node 31, as a server, transmits data transferred from the IPv4 node 31 through the fourth socket by calling a send (IPv4) in the application layer, with the send (IPv4) including information about the fourth socket and the data transferred from the IPv4 node 31 (operation 617). Then, the node 11, as a client, receives the data transferred from the IPv4 node 31 through the second socket by calling a recv (IPv4) in the application layer, with the recv (IPv4) including information about the second socket and the data transferred from the IPv4 node 31 (operation 618). Thereafter, the node 11, as a server, transmits the data transferred from the IPv4 node 31 through the first socket by calling a send (IPv6) in the application layer, with the send (IPv6) including information about the first socket and the data transferred from the IPv4 node 31 (operation 619). This process is applicable to the IPv4 to IPv6 transition process in the application layer. Next, the IPv6 node 21, as a client, receives data transferred from the IPv4 node 31 through the third socket by calling a recv (IPv6) in the application layer, with the recv (IPv6) including information about the fourth socket and the data transferred from the IPv4 node 31 (operation 620). The IPv6 node 21 processes the data transferred from the IPv4 node 31. In case of a non-mobile communication such as UDP, a sendto ( ) and a recvfrom ( ) are called instead of the send ( ) and the recv ( ), respectively.

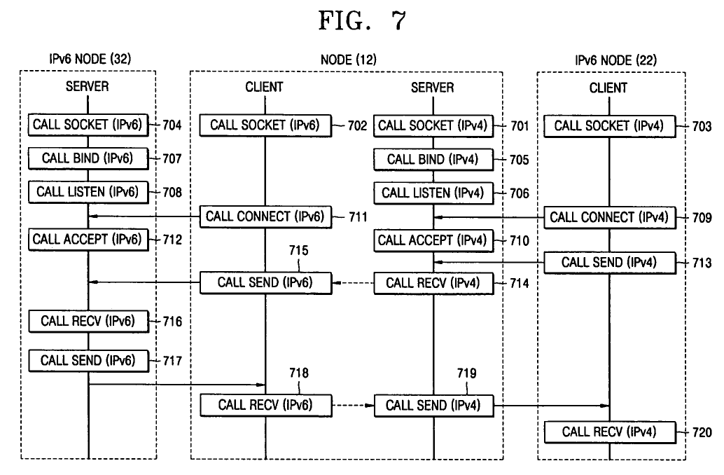

FIG. 7 is a flowchart of another method of connecting heterogeneous protocol nodes according to another exemplary embodiment of the present invention.

Referring to FIG. 7, the method of connecting heterogeneous protocol nodes includes operations of as described below. This method of connecting heterogeneous protocol nodes can be implemented in the network environment illustrated in FIG. 3. for example.

First, the node 12, as a server and client, generates the first socket by calling a socket (IPv4) in the application layer, the socket (IPv4) including information about IPv4, and the second socket by calling a socket (IPv6) in the application layer, the socket (IPv6) including information about IPv6 (operations 701 and 702). At the same time, the IPv4 node 22 generates the third socket by calling a socket (IPv4) that includes information about IPv4, and the IPv6 node 32 generates the fourth socket by calling a socket (IPv6) that includes information about IPv6 (operations 703 and 704).

Subsequently, the node 12, as a server, connects an address of the node 12 with the first socket by calling a bind (IPv4) in the application layer, with the bind (IPv4) including information about the first socket and an address of the node 12 set as a destination by the IPv4 node 22 (operation 705). Next, the node 12, as a server, waits to receive a connection request of which destination is an address connected with the first socket by calling a listen (IPv4) in the application layer, with the listen (IPv4) including information about the first socket (operation 706). Simultaneously, the IPv6 node 32, as a server, connects an address of the IPv6 node 32 with the fourth socket by calling a bind (IPv6) in the application layer, with the bind (IPv6) including information about the fourth socket and an address of the node 12 set as a destination by the IPv6 node 32 (operation 707). Then the IPv6 node 32, as a server, waits to receive a connection request of which destination is an address connected with the fourth socket by calling a listen (IPv6) in the application layer, with the listen (IPv6) including information the fourth socket (operation 708).

Thereafter, the IPv4 node 22, as a client, requests to connect to the node 12 by calling a connect (IPv4) in the application layer, with the connect (IPv4) including information about the third socket and an address of the node 12 that waits to receive a connection request (operation 709). Next, the node 12, as a server, admits the connection request by calling an accept (IPv4) in the application layer, with the accept (IPv4) including information about the first socket, and an address of the IPv4 node 22 that sent the connection request (operation 710). At the same time, the node 12, as a client, requests to connect to the IPv6 node 32 by calling a connect (IPv6) in the application layer, with the connect (IPv6) including information about the second socket and an address of the IPv6 node 32 that waits to receive a connection request (operation 711). Then the IPv6 node 32 admits the received connection request by calling an accept (IPv6) in the application layer, the accept (IPv6) including information of the fourth socket and an address of the node 12 that sent the connection request (operation 712). In case of a non-mobile communication such as UDP, the operations of calling a listen ( ), a connect ( ), and an accept ( ) are omitted.

Next, the IPv4 node 22, as a client, transmits data transferred from the IPv4 node 22 through the third socket by calling a send (IPv4) in the application layer, with the send (IPv4) including information about the third socket and the data transferred from the IPv4 node 22 (operation 713). Subsequently, the node 12, as a server, receives data transferred from the IPv4 node 22 through the first socket by calling a recv (IPv4) in the application layer, with the recv (IPv4) including information about the first socket and data transferred from the IPv4 node 22 (operation 714). Thereafter the node 12 transmits data transferred from the IPv4 node 22 through the second socket by calling a send (IPv6) in the application layer, the data including information about the second socket and data transferred from the IPv4 node 22 (operation 715). This process is applicable to the IPv4 to IPv6 transition process in the application layer. Next, the IPv6 node 32, as a server, receives data transferred from the IPv4 node 22 through the fourth socket by calling a recv (IPv6) in the application layer, with the recv (IPv6) including information the fourth socket and the data transferred from the IPv4 node 22 (operation 716). The IPv6 node 32 processes the data transferred from the IPv4 node 22.

Subsequently, the IPv6 node 32, as a server, transmits data transferred from the IPv6 node 32 through the fourth socket by calling a send (IPv6) in the application layer, with the send (IPv6) including information about the fourth socket and the data transferred from the IPv6 node 32 (operation 717). Then, the node 12, as a client, receives the data transferred from the IPv6 node 32 through the second socket by calling a recv (IPv6) in the application layer, with the recv (IPv6) including information about the second socket and the data transferred from the IPv6 node 32 (operation 718). Thereafter, the node 12, as a server, transmits the data transferred from the IPv6 node 32 through the first socket by calling a send (IPv4) in the application layer, with the send (IPv4) including information about the first socket and the data transferred from the IPv6 node 32 (operation 719). This process is applicable to the IPv6 to IPv4 transition process in the application layer. Next, the IPv4 node 22, as a client, receives data transferred from the IPv6 node 32 through the third socket by calling a recv (IPv4) in the application layer, with the recv (IPv4) including information about the fourth socket and the data transferred from the IPv6 node 32 (operation 720). The IPv4 node 22 processes the data transferred from the IPv6 node 32. In case of a non-mobile communication such as UDP, a sendto ( ) and a recvfrom ( ) are called instead of the send ( ) and the recv ( ), respectively.

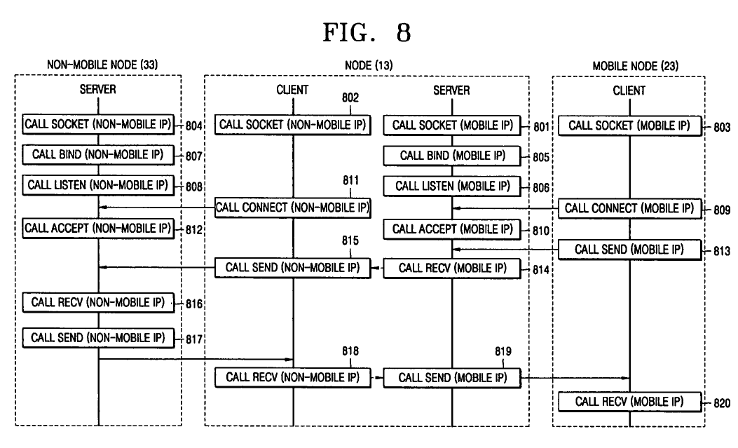

FIG. 8 is a flowchart of another method of connecting heterogeneous protocol nodes according to still another exemplary embodiment of the present invention.

Referring to FIG. 8, the method of connecting heterogeneous protocol nodes includes operations of as described below. The method of connecting heterogeneous protocol nodes can be implemented in the network environment illustrated in FIG. 4, for example.

First, the node 13, as a server and client, generates the first socket by calling a socket (mobile IP) in the application layer, the socket (mobile IP) including information about the mobile IP, and the second socket by calling a socket (non-mobile IP) in the application layer, the socket (non-mobile IP) including information about the non-mobile IP (operations 801 and 802). At the same time, the mobile node 23 generates the third socket by calling a socket (mobile IP) that includes information about the mobile IP, and the non-mobile node 33 generates the fourth socket by calling a socket (non-mobile IP) that includes information about the non-mobile IP (operations 803 and 804).

Subsequently, the node 13, as a server, connects an address of the node 13 with the first socket by calling a bind (mobile IP) in the application layer, with the bind (mobile IP) including information about the first socket and an address of the node 13 set as a destination by the mobile node 23 (operation 805). Next, the node 13, as a server, waits to receive a connection request of which destination is an address connected with the first socket by calling a listen (mobile IP) in the application layer, with the listen (mobile IP) including information about the first socket (operation 806). Simultaneously, the non-mobile node 33, as a server, connects an address of the non-mobile IP node 33 with the fourth socket by calling a bind (non-mobile IP) in the application layer, with the bind (non-mobile IP) including information about the fourth socket and an address of the non-mobile node 33 set as a destination by the node 13 (operation 807). Then the non-mobile node 33, as a server, waits to receive a connection request of which destination is an address connected with the fourth socket by calling a listen (non-mobile IP) in the application layer, with the listen (non-mobile IP) including information the fourth socket (operation 808).

Thereafter, the mobile node 23, as a client, requests to connect to the node 13 by calling a connect (mobile IP) in the application layer, with the connect (mobile IP) including information about the third socket and an address of the node 13 that waits to receive a connection request (operation 809). Next, the node 13, as a server, admits the connection request by calling an accept (mobile IP) in the application layer, with the accept (mobile IP) including information about the first socket, and an address of the mobile node 23 that sent the connection request (operation 810). At the same time, the node 13, as a client, requests to connect to the non-mobile node 33 by calling a connect (non-mobile IP) in the application layer, with the connect (non-mobile IP) including information about the second socket and an address of the non-mobile node 33 that waits to receive a connection request (operation 811). Then the non-mobile node 33 admits the received connection request by calling an accept (non-mobile IP) in the application layer, the accept (non-mobile IP) including information the fourth socket, and an address of the node 13 that sent the connection request (operation 812). In case of a non-mobile communication such as UDP, the operations of calling a listen ( ), a connect ( ), and an accept ( ) can be omitted.

Next, the mobile node 23, as a client, transmits data transferred from the mobile node 23 through the third socket by calling a send (mobile IP) in the application layer, with the send (mobile IP) including information about the third socket and information about data transferred from the mobile node 23 (operation 813). Subsequently, the node 13, as a server, receives data transferred from the mobile node 23 through the first socket by calling a recv (mobile IP) in the application layer, with the recv (mobile IP) including information about the first socket and data transferred from the mobile node 23 (operation 814). Thereafter the node 13 transmits data transferred from the mobile node 23 through the second socket by calling a send (non-mobile IP) in the application layer, the data including information about the second socket and data transferred from the mobile node 23 (operation 815). This process is applicable to the mobile IP to non-mobile IP transition process in the application layer. Next, the non-mobile node 33, as a server, receives data transferred from the mobile node 23 through the fourth socket by calling a recv (non-mobile IP) in the application layer, with the recv (non-mobile IP) including information the fourth socket and the data transferred from the mobile node 23 (operation 816). The non-mobile node 33 processes the data transferred from the mobile node 23.

Subsequently, the non-mobile node 33, as a server, transmits data transferred from the non-mobile node 33 through the fourth socket by calling a send (non-mobile IP) in the application layer, with the send (non-mobile IP) including information about the fourth socket and the data transferred from the non-mobile node 33 (operation 817). Then, the node 13, as a client, receives the data transferred from the non-mobile node 33 through the second socket by calling a recv (non-mobile IP) in the application layer, with the recv (non-mobile IP) including information about the second socket and the data transferred from the non-mobile node 33 (operation 818). Thereafter, the node 13, as a server, transmits the data transferred from the non-mobile node 33 through the first socket by calling a send (mobile IP) in the application layer, with the send (mobile IP) including information about the first socket and the data transferred from the non-mobile node 33 (operation 819). This process is applicable to the non-mobile IP to mobile IP transition process in the application layer. Next, the mobile node 23, as a client, receives data transferred from the non-mobile node 33 through the third socket by calling a recv (mobile IP) in the application layer, with the recv (mobile IP) including information about the fourth socket and the data transferred from the non-mobile IP 31 (operation 820). The mobile node 23 processes the data transferred from the non-mobile node 33. In case of a non-mobile communication such as UDP, a sendto ( ) and a recvfrom ( ) are called instead of the send ( ) and the recv ( ), respectively.

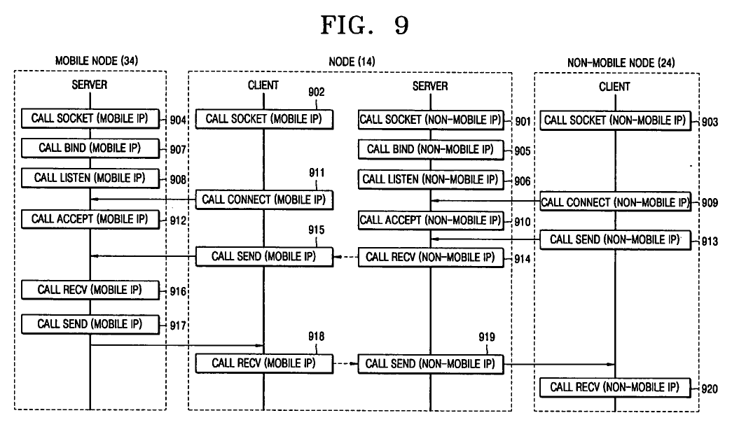

FIG. 9 is a flowchart of another method of connecting heterogeneous protocol nodes according to yet another exemplary embodiment of the present invention.

Referring to FIG. 9, the method of connecting heterogeneous protocol nodes includes operations of as described below. The method of connecting heterogeneous protocol nodes is implemented in the network environment illustrated in FIG. 5, for example.

First, the node 14, as a server and client, generates the first socket by calling a socket (non-mobile IP) in the application layer, the socket (non-mobile IP) including information about the non-mobile IP, and the second socket by calling a socket (mobile IP) in the application layer, the socket (mobile IP) including information about the mobile IP (operations 901 and 902). At the same time, the non-mobile node 24 generates the third socket by calling a socket (non-mobile IP) that includes information about the non-mobile IP, and the mobile node 34 generates the fourth socket by calling a socket (mobile IP) that includes information about the mobile IP (operations 903 and 904).

Subsequently, the node 14, as a server, connects an address of the node 14 with the first socket by calling a bind (non-mobile IP) in the application layer, with the bind (non-mobile IP) including information about the first socket and an address of the node 14 set as a destination by the non-mobile node 24 (operation 905). Next, the node 14, as a server, waits to receive a connection request of which destination is an address connected with the first socket by calling a listen (non-mobile IP) in the application layer, with the listen (non-mobile IP) including information about the first socket (operation 906). Simultaneously, the mobile node 34, as a server, connects an address of the mobile IP node 34 with the fourth socket by calling a bind (mobile IP) in the application layer, with the bind (mobile IP) including information about the fourth socket (operation 907). Then the mobile node 34, as a server, waits to receive a connection request of which destination is an address connected with the fourth socket by calling a listen (mobile IP) in the application layer, with the listen (mobile IP) including information the fourth socket (operation 908).

Thereafter, the non-mobile node 24, as a client, requests to connect to the node 14 by calling a connect (non-mobile IP) in the application layer, with the connect (non-mobile IP) including information about the third socket and an address of the node 14 that waits to receive a connection request (operation 909). Next, the node 14, as a server, admits the connection request by calling an accept (non-mobile IP) in the application layer, with the accept (non-mobile IP) including information about the first socket, and an address of the non-mobile node 24 that sent the connection request (operation 910). At the same time, the node 14, as a client, requests to connect to the mobile node 34 by calling a connect (mobile IP) in the application layer, with the connect (mobile IP) including information about the second socket and an address of the mobile node 34 that waits to receive a connection request (operation 911). Then the mobile node 34 admits the received connection request by calling an accept (mobile IP) in the application layer, the accept (mobile IP) including information the fourth socket an address of the node 14 that sent the connection request (operation 912). In case of a non-mobile communication such as UDP, the operations of calling a listen ( ), a connect ( ), and an accept ( ) are omitted.

Next, the non-mobile node 24, as a client, transmits data transferred from the non-mobile node 24 through the third socket by calling a send (non-mobile IP) in the application layer, with the send (non-mobile IP) including information about the third socket and information about data transferred from the non-mobile node 24 (operation 913). Subsequently, the node 14, as a server, receives data transferred from the non-mobile node 24 through the first socket by calling a recv (non-mobile IP) in the application layer, with the recv (non-mobile IP) including information about the first socket and data transferred from the non-mobile node 24 (operation 914). Thereafter the node 14 transmits data transferred from the non-mobile node 24 through the second socket by calling a send (mobile IP) in the application layer, the data including information about the second socket and data transferred from the non-mobile node 24 (operation 915). This process is applicable to the non-mobile IP to mobile IP transition process in the application layer. Next, the mobile node 34, as a server, receives data transferred from the non-mobile node 24 through the fourth socket by calling a recv (mobile IP) in the application layer, with the recv (mobile IP) including information the fourth socket and the data transferred from the non-mobile node 24 (operation 916). The mobile node 34 processes the data transferred from the non-mobile node 24.

Subsequently, the mobile node 34, as a server, transmits data transferred from the mobile node 34 through the fourth socket by calling a send (mobile IP) in the application layer, with the send (mobile IP) including information about the fourth socket and the data transferred from the mobile node 34 (operation 917). Then, the node 14, as a client, receives the data transferred from the mobile node 34 through the second socket by calling a recv (mobile IP) in the application layer, with the recv (mobile IP) including information about the second socket and the data transferred from the mobile node 34 (operation 918). Thereafter, the node 14, as a server, transmits the data transferred from the mobile node 34 through the first socket by calling a send (non-mobile IP) in the application layer, with the send (non-mobile IP) including information about the first socket and the data transferred from the mobile node 34 (operation 919). This process is applicable to the mobile IP to non-mobile IP transition process in the application layer. Next, the non-mobile node 24, as a client, receives data transferred from the mobile node 34 through the third socket by calling a recv (non-mobile IP) in the application layer, with the recv (non-mobile IP) including information about the fourth socket and the data transferred from the mobile IP 31 (operation 920). The non-mobile node 24 processes the data transferred from the mobile node 34. In case of a non-mobile communication such as UDP, a sendto ( ) and a recvfrom ( ) are called instead of the send ( ) and the recv ( ), respectively.

Embodiments of the present invention can be implemented through computer readable code and can be implemented in general-use digital computers that execute the computer readable code using a medium, e.g., computer readable recording media. Examples of the media include magnetic storage media (e.g., ROM, floppy disks, hard disks, etc.), optical recording media (e.g., CD-ROMs, or DVDS), and storage media such as carrier waves (e.g., transmission through the Internet), for example.

According to embodiments of the present invention, it is possible to connect nodes using heterogeneous protocol with each other. For example, an IPv4 node can be connected with an IPv6 node, and a non-mobile node can be connected with a mobile node. Especially, users or terminal distributors can easily carry out the present invention since the present invention is possible to be performed in the application layer that the users or the terminal distributors can manage.

While embodiments of this invention have been particularly shown and described, it will be understood by those skilled in the art that various changes in form and details may be made therein without departing from the spirit and scope of the invention as defined by the appended claims. The described embodiments should be considered in descriptive sense only and not for purposes of limitation. Therefore, the scope of the invention is defined not by the detailed description of the invention but by the appended claims, and all differences within the scope will be construed as being included in the present invention.

1. A method of connecting heterogeneous protocol nodes, the method comprising:
receiving first data transferred from a first node, which uses a first protocol, through a first socket; and
transmitting the received first data to a second node, which uses a second protocol, through a second socket.

2. The method of claim 1, wherein the first protocol is IPv6 and the second protocol is IPv4, or the second protocol is IPv6 and the first protocol is IPv4.

3. The method of claim 1, wherein the first protocol is a mobile IP and the second protocol is a non-mobile IP, or the second protocol is the mobile IP and the first protocol is the non-mobile IP.

4. The method of claim 1, wherein in the receiving of the first data transferred from the first node, the first data is received through the first socket by calling a receive function in an application layer, with the receive function including information about the first socket and the first data, and
in the transmitting of the received first data to the second node, the received first data is transmitted through the second socket by calling a send function in the application layer, with the send function including information about the second socket and the information about the first data.

5. The method of claim 1, further comprising:
generating the first socket and the second socket to be used in communication based on the first protocol and the second protocol, respectively,
wherein in the receiving of the first data transferred from the first node, the first data is received through the first socket generated in the generating of the first and second sockets, and
in the transmitting of the received first data to the second node, the received first data is transmitted through the second socket generated in the generating of the first and second sockets.

6. The method of claim 1, further comprising:
generating the first socket and the second socket to be used in communication based on the first protocol and the second protocol, respectively; and
connecting the generated first socket to the first node and connecting the generated second socket to the second node,
wherein in the receiving of the first data transferred from the first node, the first data is received through the first socket connected in the generating of the first and second sockets, and
in the transmitting of the received first data to the second node, the received first data is transmitted through the second socket connected in the generating of the first and second sockets.

7. An apparatus for connecting heterogeneous protocol nodes, the apparatus comprising:
a first socket communicating unit receiving first data through a first socket, the first data transferred from a first node using a first protocol; and
a second socket communicating unit transmitting the first data received by the first socket communicating unit to a second node through a second socket.

8. The apparatus of claim 7, wherein the first protocol is IPv6 and the second protocol is IPv4, or the second protocol is IPv6 and the first protocol is IPv4.

9. The apparatus of claim 7, wherein the first protocol is a mobile IP and the second protocol is a non-mobile IP, or the second protocol is the mobile IP and the first protocol is the non-mobile IP.

10. The apparatus of claim 7, wherein the first socket communicating unit receives data through the first socket by calling a receive function in an application layer, with the receive function including information about the first socket and the received data, and
the second socket communicating unit transmits the received data through the second socket by calling a send function in an application layer, with the send function including information about the second socket and the information about the received data.

11. The apparatus of claim 7, further comprising:
a dual socket generating unit generating the first socket and the second socket to be used in communication based on the first protocol and the second protocol, respectively,
wherein the first socket communicating unit receives data, through the first socket generated by the dual socket generating unit, and the second socket communicating unit sends data through the second socket, generated by the dual socket generating unit.

12. The apparatus of claim 7, further comprising:
a dual socket generating unit generating the first socket and second socket to be used in the first protocol based communication and the second protocol based communication, respectively; and
a dual socket connecting unit connecting the first socket with the first node and the second socket with the second node, with the first and second sockets being generated by the dual socket generating unit,
wherein the first socket communicating unit receives data through the first socket, connected by the dual socket connecting unit, and the second socket communicating unit sends data through the second socket, connected by the dual socket connecting unit.

13. A method of connecting heterogeneous protocol nodes, the method comprising:
generating a first socket and a second socket to be used in a first protocol based communication and a second protocol based communication, respectively; and
communicating with a first node that uses the first protocol through the first socket generated in the generating of the first and second sockets and with a second node that uses the second protocol through the second socket generated in the generating of the first and second sockets.

14. The method of claim 13, wherein the first protocol is IPv6 and the second protocol is IPv4, or the second protocol is IPv6 and the first protocol is IPv4.

15. The method of claim 13, wherein the first protocol is a mobile IP and the second protocol is a non-mobile protocol, or the second protocol is the mobile IP and the second protocol is the non-mobile protocol.

16. The method of claim 13, wherein in the generating of the first and second sockets, the first socket and the second socket, which are application program interfaces, are generated by calling predetermined functions in an application layer.

17. The method of claim 13, wherein in the communicating, communication is performed through the first socket and the second socket, which are application program interfaces, by calling predetermined functions in an application layer.

18. A medium comprising computer readable code implementing a connecting of heterogeneous protocol nodes, comprising:
receiving first data through a first socket, with the first data being transferred from a first node which uses a first protocol; and
sending the received data to a second node, through a second socket, with the second node using the second protocol.

19. A medium comprising computer readable code implementing a communicating with heterogeneous protocol nodes, comprising:
generating a first socket and a second socket, to be used in communication based on a first protocol and a second protocol, respectively; and
communicating with a first node, which uses the first protocol, through the generated first socket, and with a second node, which uses the second protocol, through the generated second socket.
